(19) United States
(12) Patent Application Publication
(10) Pub. No.: US 2016/0125832 A1
(43) Pub. Date: May 5, 2016

(54) DISPLAY APPARATUS AND METHOD OF DRIVING THE SAME

(71) Applicant: Samsung Display Co., Ltd., Yongin-si (KR)

(72) Inventors: Jun-Ho HWANG, Asan-si (KR); Hee-Bum PARK, Seongnam-si (KR); Won-Jin SEO, Seoul (KR)

(21) Appl. No.: 14/713,301

(22) Filed: May 15, 2015

(30) Foreign Application Priority Data
Oct. 30, 2014 (KR) 10-2014-0149468

(51) Int. Cl. G09G 3/36

(52) U.S. Cl. CPC G09G 3/3696; G09G 3/3648; G09G 2320/0219; G09G 2310/08; G09G 2310/0289

(57) ABSTRACT

A display apparatus includes a display panel, a gate driver, a counter and a power generator. The display panel includes a gate line and a pixel electrically connected to the gate line. The gate driver is configured to set a voltage level and an output timing of a gate signal applied to the gate line based on a gate driving voltage and a first control signal. The gate driving voltage includes a gate on voltage and a gate off voltage. The counter is configured to increase a count value based on the first control signal. The power generator is configured to adjust a level of the gate driving voltage based on the count value.

### CLAIM PRIORITY

This application makes reference to, incorporates the same herein, and claims all benefits accruing under 35 U.S.C. §119 from an application earlier filed in the Korean Intellectual Property Office on 30 Oct. 2014 and there duly assigned Serial No. 10-2014-0149468.

### BACKGROUND OF THE INVENTION

1. Field of Invention

Exemplary embodiments of the present inventive concept relate to a display apparatus and a method of driving the display apparatus. More particularly, exemplary embodiments of the present inventive concept relate to a display apparatus improving a display quality and a method of driving the display apparatus.

2. Description of the Related Art

Generally, a display apparatus includes a plurality of thin film transistors (TFTs) and a pixel electrode electrically connected to the thin film transistors. The thin film transistor includes a semiconductor material having a conductivity in a specific condition to function as a switching element. The semiconductor material may be one of a silicon semiconductor, an organic semiconductor and an oxide semiconductor.

For example, the oxide semiconductor includes In—Ga—Zn—O material and a proportion of elements may be adjusted to have a conductivity. The oxide semiconductor has an electric mobility higher than the silicon semiconductor so that a switching characteristic of the thin film transistor may be improved. However, a threshold voltage of the oxide semiconductor is shifted so that a driving reliability of the thin film transistor may be deteriorated.

The above information disclosed in this Related Art section is only for enhancement of understanding of the background of the invention and therefore it may contain information that does not form the prior art that is already known to a person of ordinary skill in the art.

### SUMMARY OF THE INVENTION

Exemplary embodiments of the present inventive concept provide a display apparatus capable of improving a display quality by adjusting a gate voltage corresponding to shift of a threshold voltage of a thin film transistor.

Exemplary embodiments of the present inventive concept also provide a method of driving the display apparatus.

In an exemplary embodiment of a display apparatus according to the present inventive concept, the display apparatus includes a display panel, a gate driver, a counter and a power generator. The display panel includes a gate line and a pixel electrically connected to the gate line. The gate driver is configured to set a voltage level and an output timing of a gate signal applied to the gate line based on a gate driving voltage and a first control signal. The gate driving voltage includes a gate on voltage and a gate off voltage. The counter is configured to increase a count value based on the first control signal. The power generator is configured to adjust a level of the gate driving voltage based on the count value.

In an exemplary embodiment, the first control signal may include a vertical start signal to start an operation of the gate driver. The counter may be configured to increase the count value based on an output of the vertical start signal.

In an exemplary embodiment, as the count value increases, the power generator may decrease a level of the gate driving voltage.

In an exemplary embodiment, the display apparatus may further include a comparator configured to receive a gate voltage setting data including a level of the gate driving voltage according to a driving time of the display apparatus, to compare the count value to the gate voltage setting data and to generate a power control signal. The power generator may adjust a level of the gate driving voltage based on the power control signal.

In an exemplary embodiment, the display apparatus may further include a timing controller configured to output the first control signal for controlling a driving timing of the gate driver, to receive the gate voltage setting data from an external memory and to output the gate voltage setting data to the comparator.

In an exemplary embodiment, the power generator may include an output resistor to which the gate off voltage is applied, a first feedback resistor connected to the output resistor and a voltage compensating circuit connected to the output resistor and the first feedback resistor. The voltage compensating circuit may be configured to adjust a level of the gate off voltage based on the power control signal.

In an exemplary embodiment, the voltage compensating circuit may include a second feedback resistor and a switching element connected to the second feedback resistor in series. A gate electrode of the switching element may be electrically connected to the comparator to receive the power control signal.

In an exemplary embodiment, the display apparatus may further include a memory configured to store the count value in a predetermined time cycle.

In an exemplary embodiment of a method of driving a display apparatus according to the present inventive concept, the method includes increasing a count value based on a first control signal, the first control signal being for controlling an operation of a gate driver, outputting a power control signal based on the count value and adjusting a level of a gate driving voltage applied to the gate driver based on the power control signal.

In an exemplary embodiment, the gate driving voltage may include a gate on voltage and a gate off voltage. The gate on voltage and the gate off voltage may determine a level of a gate signal. The first control signal may include a vertical start signal to start an operation of the gate driver. The count value may increase based on an output of the vertical tart signal.

In an exemplary embodiment, as the count value increases, the power generator may decrease a level of the gate driving voltage.

In an exemplary embodiment, the method may further include receiving a gate voltage setting data including a level of the gate driving voltage according to a driving time of the display apparatus and comparing the count value to the gate voltage setting data to generate a power control signal.

In an exemplary embodiment, the method may further include storing the power control signal to a first memory and reading the power control signal from the first memory by I²C protocol.

In an exemplary embodiment, the adjusting the level of the gate driving voltage may use a power generator comprising an output resistor to which the gate off voltage is applied and a voltage compensating circuit connected to the output resistor and the first feedback resistor. The voltage compensating circuit may be configured to adjust a level of the gate off voltage based on the power control signal.

In an exemplary embodiment, the voltage compensating circuit may include a second feedback resistor and a switching element connected to the second feedback resistor in series. A gate electrode of the switching element may be electrically connected to the comparator to receive the power control signal.

In an exemplary embodiment, the method may further include storing the count value in a predetermined time cycle.

According to the display apparatus and the method of driving the display apparatus, a gate driving voltage applied to a gate driver is adjusted according to a driving time of the display apparatus so that a driving reliability of a thin film transistor may be improved. Thus, a display quality of the display apparatus may be improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating a display apparatus according to an exemplary embodiment of the inventive concept;

FIG. 2 is a block diagram illustrating a timing controller and a power generator of FIG. 1;

FIG. 3 is a block diagram illustrating a gate driving voltage compensator of FIG. 2;

FIG. 4 is a block diagram illustrating a display apparatus according to an exemplary embodiment of the inventive concept;

FIG. 5 is a block diagram illustrating a timing controller, a gate driving voltage compensator and a power generator of FIG. 4;

FIG. 6 is a block diagram illustrating a gate driving voltage compensator of FIG. 5;

FIG. 7 is a block diagram illustrating a display apparatus according to an exemplary embodiment of the inventive concept;

FIG. 8 is a block diagram illustrating a timing controller and a power generator of FIG. 7;

FIG. 9 is a block diagram illustrating a gate driving voltage compensator of FIG. 8;

FIG. 10 is a block diagram illustrating a display apparatus according to an exemplary embodiment of the inventive concept; and

FIG. 11 is a block diagram illustrating a timing controller, a gate driving voltage compensator and a power generator of FIG. 10.

### DETAILED DESCRIPTION OF THE EMBODIMENTS

Hereinafter, the inventive concept will be explained in detail with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

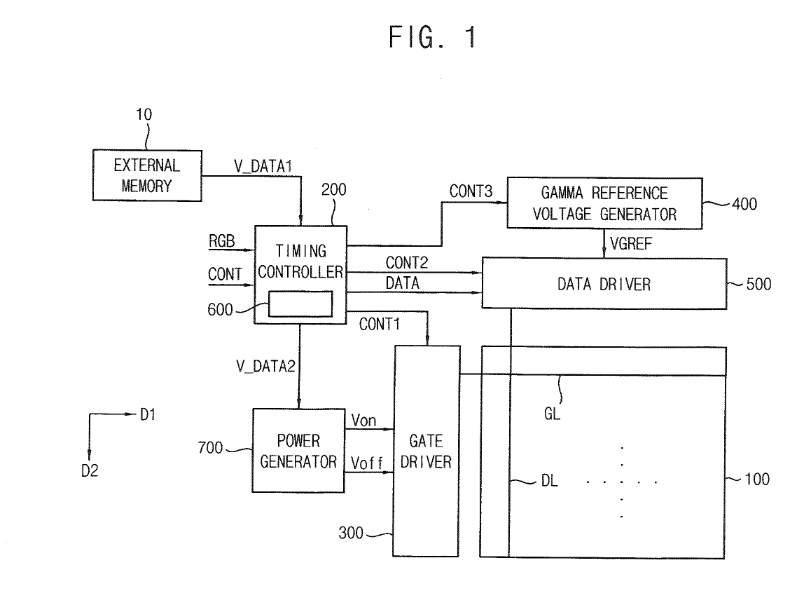

FIG. 1 is a block diagram illustrating a display apparatus according to an exemplary embodiment of the inventive concept.

Referring to FIG. 1, the display apparatus includes a display panel 100, a panel driver and a power generator 700. The panel driver includes a timing controller 200, a gate driver 300, a gamma reference voltage generator 400 and a data driver 500.

The display panel 100 displays an image. The display panel 100 has a display region on which an image is displayed and a peripheral region adjacent to the display region.

The display panel 100 includes a plurality of gate lines GL, a plurality of data lines DL and a plurality of pixels connected to the gate lines GL and the data lines DL. The gate lines GL extend in a first direction D1 and the data lines DL extend in a second direction D2 crossing the first direction D1.

Each pixel includes a switching element (not shown), a liquid crystal capacitor (not shown) and a storage capacitor (not shown). The liquid crystal capacitor and the storage capacitor are electrically connected to the switching element. The pixels may be disposed in a matrix form.

The timing controller 200 receives input image data RGB and an input control signal CONT from an external apparatus (not shown). The input image data may include red image data, green image data and blue image data. The input control signal CONT may include a master clock signal and a data enable signal. The input control signal CONT may further include a vertical synchronizing signal and a horizontal synchronizing signal.

The timing controller 200 may receive a gate voltage setting data V_DATA1 from an external memory 10. The external memory 10 may be an electrically erasable programmable read-only memory (EEPROM).

The timing controller 200 generates a first control signal CONT1, a second control signal CONT2, a third control signal CONT3 and a data signal DATA based on the input image data RGB and the input control signal CONT. The timing controller 200 generates a power control signal V_DATA2 based on the gate voltage setting data V_DATA1 and the first control signal CONT1.

The timing controller 200 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 200 generates the data signal DATA based on the input image data RGB. The timing controller 200 outputs the data signal DATA to the data driver 500.

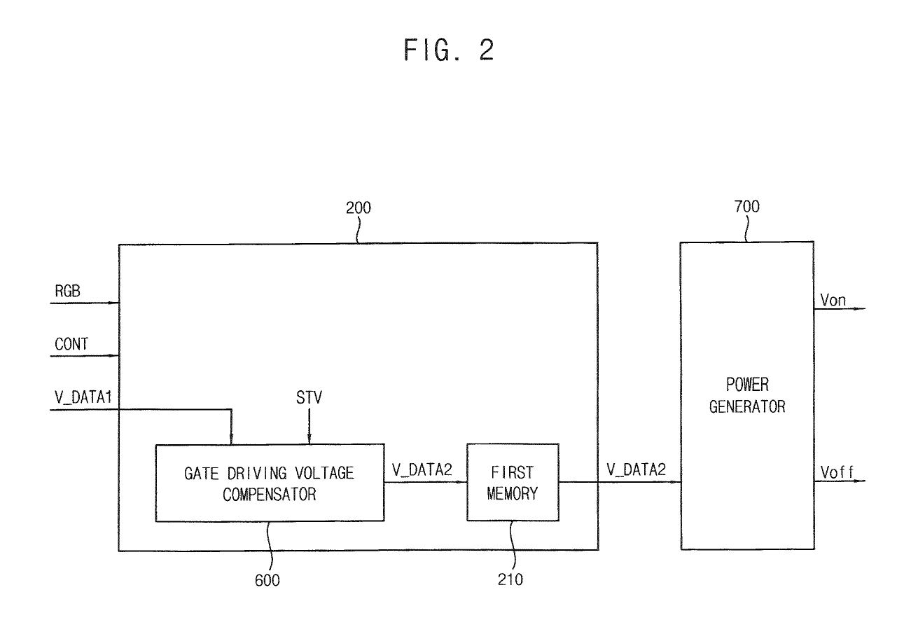

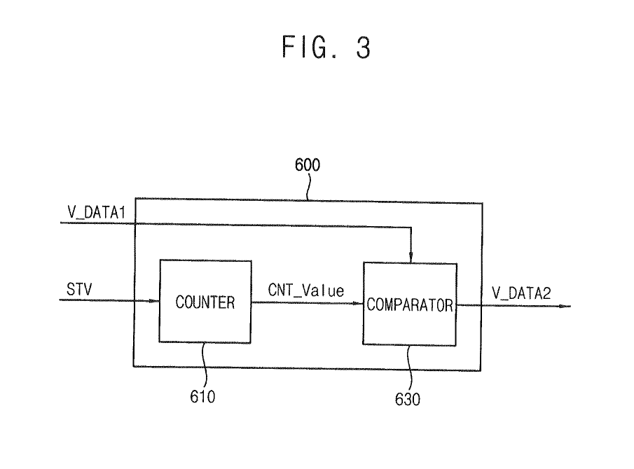

The timing controller 200 generates the power control signal V_DATA2 for controlling an output of the power generator 700 based on the gate voltage setting data V_DATA1 and the first control signal CONT1. The timing controller 200 outputs the power control signal V_DATA2 to the power generator 700. The timing controller 200 includes a gate driving voltage compensator 600 generating the power control signal V_DATA2. For example, the gate driving voltage compensator 600 may generate the power control signal V_DATA2 based on the gate voltage setting data V_DATA1 and the vertical start signal. A structure and an operation of the gate driving voltage compensator 600 is explained in detail referring to FIGS. 2 and 3.

The power generator 700 may output a gate on voltage Von and a gate off voltage Voff based on the power control signal V_DATA2. A level of the gate on voltage may be adjusted based on the power control signal V_DATA2. A level of the gate on voltage may be adjusted based on the power control signal V_DATA2.

The gate driver 300 may receive the first control signal CONT1 from the timing controller 200. The gate driver 300 may receive the gate on voltage Von and the gate off voltage Voff from the power generator 700.

The gate driver 300 generates gate signals driving the gate lines GL based on the gate on voltage Von and the gate off voltage Voff in response to the first control signal CONT1 received from the timing controller 200. The gate signal may include a turn on voltage to turn on the switching element of the pixel and a turn off voltage to turn off the switching element. The gate driver 300 sequentially outputs the gate signals to the gate lines GL.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DATA. In an exemplary embodiment, the gamma reference voltage generator 400 may be disposed in the timing controller 200, or in the data driver 500.

The data driver 500 receives the second control signal CONT2 and the data signal DATA from the timing controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

FIG. 2 is a block diagram illustrating the timing controller 200 and the power generator 700 of FIG. 1. FIG. 3 is a block diagram illustrating a gate driving voltage compensator 600 of FIG. 2.

Referring to FIGS. 1 to 3, the timing controller 200 includes the gate driving voltage compensator 600 and a first memory 210.

The gate driving voltage compensator 600 may generate the power control signal V_DATA2 based on the gate voltage setting data V_DATA1 received from the external memory 10 and the first control signal CONT1. The gate driving voltage compensator 600 may output the power control signal V_DATA2. For example, the gate driving voltage compensator 600 may generate the power control signal V_DATA2 based on the gate voltage setting data V_DATA1, the vertical start signal STV of the first control signal CONT1. The vertical start signal STV is a signal to start an operation of the gate driver 300.

The gate voltage setting data V_DATA1 may include setting values to adjust output values of the power generator 700 according to driving time of the display apparatus. For example, when the driving time of the display apparatus increases, the setting values of the gate voltage setting data V_DATA1 reduce the gate off voltage Voff of the output of the power generator 700. For example, when the driving time of the display apparatus increases, the setting values of the gate voltage setting data V_DATA1 reduce the gate on voltage Von of the output of the power generator 700.

The gate driving voltage compensator 600 may include a counter 610 and a comparator 630.

The counter 610 may count the driving time of the display apparatus and may output a count value CNT_Value. For example, the counter 610 may count the number of the vertical start signal STV outputted from the timing controller 200 to output the count value CNT_Value. The count value CNT_Value may be accumulated for every vertical start signal STV. Alternatively, the count value CNT_Value may be accumulated for some vertical start signals STV.

The comparator 630 compares the count value CNT_Value to the gate voltage setting data V_DATA1 and outputs the power control signal V_DATA2. The gate voltage setting data V_DATA1 includes setting values to decrease a level of the gate off voltage Voff as the driving time of the display apparatus increases. Thus, the comparator 630 determines the driving time corresponding to the count value CNT_Value and outputs the power control signal V_DATA2 based on the setting value which corresponds to the determined driving time.

The first memory 210 may receive the power control signal V_DATA2 from the comparator 630. The first memory 210 may store the power control signal V_DATA2.

The power generator 700 may receive the power control signal V_DATA2 from the first memory 210. The power generator 700 may adjust the level of the gate off voltage Voff based on the power control signal V_DATA2 and output the gate off voltage Voff. The power generator 700 may further adjust the level of the gate on voltage Von based on the power control signal V_DATA2 and output the gate on voltage Von.

The power generator 700 may communicate with the first memory 210 by I²C protocol. For example, the power generator 700 may read the power control signal V_DATA2 from the first memory 210 by I²C protocol.

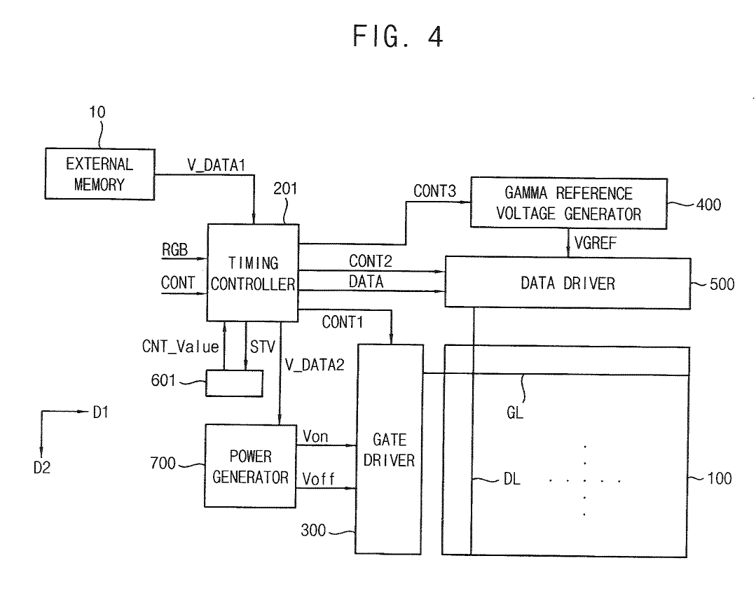

FIG. 4 is a block diagram illustrating a display apparatus according to an exemplary embodiment of the inventive concept.

The display apparatus according to the illustrated exemplary embodiment is substantially the same as the display apparatus in FIGS. 1 to 3 except for a timing controller 201 and a gate driving power compensator 601. Thus, the same reference numerals will be used to refer to same or like parts as those described in with reference to FIGS. 1 to 3 and any further repetitive explanation concerning the above elements will be omitted.

Referring to FIG. 4, the display apparatus includes a display panel 100, a panel driver and a power generator 700. The panel driver includes a timing controller 201, a gate driver 300, a gamma reference voltage generator 400, a data driver 500 and a gate driving voltage compensator 601.

The timing controller 201 receives input image data RGB and an input control signal CONT from an external apparatus. The timing controller 201 may receive a gate voltage setting data V_DATA1 from an external memory 10. The external memory 10 may be an electrically erasable programmable read-only memory (EEPROM).

The timing controller 201 generates a first control signal CONT1, a second control signal CONT2, a third control signal CONT3 and a data signal DATA based on the input image data RGB and the input control signal CONT.

The timing controller 201 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 201 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 201 generates the data signal DATA based on the input image data RGB. The timing controller 201 outputs the data signal DATA to the data driver 500.

The timing controller 201 may output the first control signal CONT1 to the gate driving voltage compensator 601. For example, the timing controller 201 may output the vertical start signal STV of the first control signal CONT1 to the gate driving voltage compensator 601.

The driving voltage compensator 601 may count the driving time of the display apparatus and may output a count value CNT_Value. For example, the driving voltage compensator 601 may count the number of the vertical start signal STV to output the count value CNT_Value.

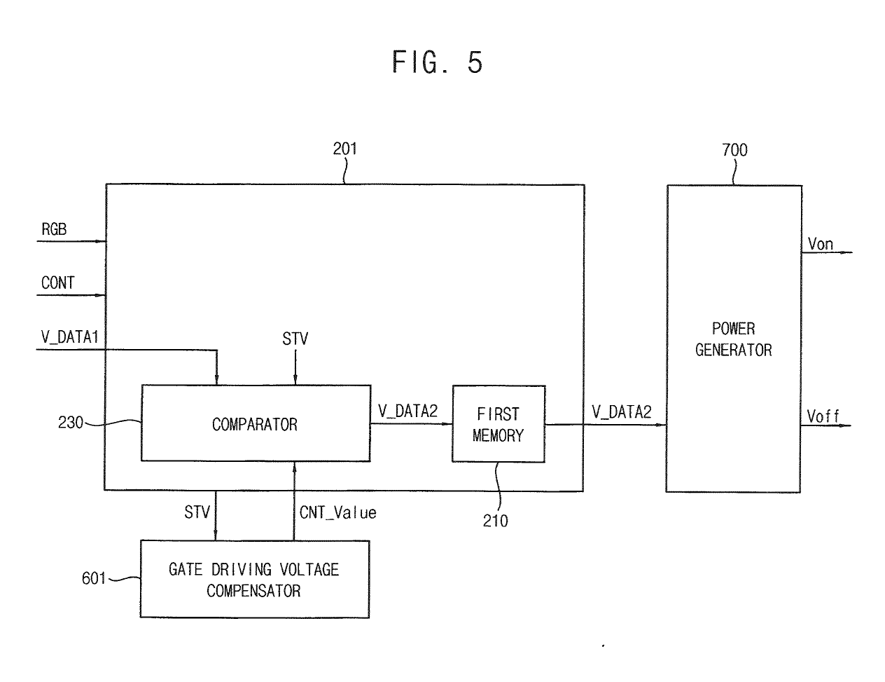

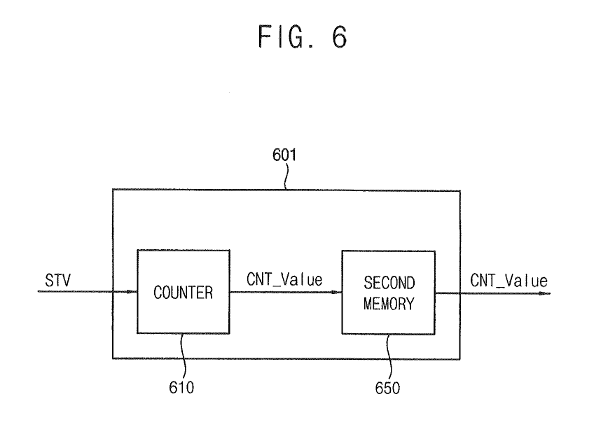

The timing controller 201 may generate the power control signal V_DATA2 for controlling an output of the power generator 700 based on the gate voltage setting data V_DATA1 and the count value CNT_Value. The timing controller 201 may output the power control signal V_DATA2 to the power generator 700. The timing controller 201 includes a comparator generating the power control signal V_DATA2. For example, the comparator may generate the power control signal V_DATA2 based on the count value CNT_Value received from the gate driving voltage compensator 601. A structure and an operation of the comparator and the gate driving voltage compensator 601 are explained in detail referring to FIGS. 5 and 6.

The power generator 700 may output a gate on voltage Von and a gate off voltage Voff based on the power control signal V_DATA2. A level of the gate on voltage may be adjusted based on the power control signal V_DATA2. A level of the gate on voltage may be adjusted based on the power control signal V_DATA2.

The gate driver 300 may receive the first control signal CONT1 from the timing controller 201. The gate driver 300 may receive the gate on voltage Von and the gate off voltage Voff from the power generator 700.

The gate driver 300 generates gate signals driving the gate lines GL based on the gate on voltage Von and the gate off voltage Voff in response to the first control signal CONT1.

FIG. 5 is a block diagram illustrating the timing controller 201, the gate driving voltage compensator 601 and the power generator 700 of FIG. 4. FIG. 6 is a block diagram illustrating the gate driving voltage compensator 601 of FIG. 5.

Referring to FIGS. 4 to 6, the timing controller 201 includes the comparator 230 and a first memory 210.

The comparator 230 may generate the power control signal V_DATA2 based on the gate voltage setting data V_DATA1 received from the external memory 10 and the count value CNT_Value received from the gate driving voltage compensator 601. The comparator 230 may output the power control signal V_DATA2.

The gate driving voltage compensator 601 may generate the count value CNT_Value based on the first control signal CONT1. The gate driving voltage compensator 601 may output the first control signal CONT1. For example, the gate driving voltage compensator 601 may generate the count value CNT_Value based on the vertical start signal STV to start an operation of the gate driver 300.

The gate voltage setting data V_DATA1 may include setting values to adjust output values of the power generator 700 according to driving time of the display apparatus. For example, when the driving time of the display apparatus increases, the setting values of the gate voltage setting data V_DATA1 reduce the gate off voltage Voff of the output of the power generator 700. For example, when the driving time of the display apparatus increases, the setting values of the gate voltage setting data V_DATA1 reduce the gate on voltage Von of the output of the power generator 700.

The gate driving voltage compensator 601 may include a counter 610 and a second memory 650.

The counter 610 may count the driving time of the display apparatus and may output a count value CNT_Value. For example, the counter 610 may count the number of the vertical start signal STV outputted from the timing controller 200 to output the count value CNT_Value. The count value CNT_Value may be accumulated for every vertical start signal STV. Alternatively, the count value CNT_Value may be accumulated for some vertical start signals STV.

The second memory 650 may store the count value CNT_Value. The second memory 650 may store the count value CNT_Value in a time cycle. For example, the time cycle may be an hour. The second memory 650 may store the count value CNT_Value in every hour.

The comparator 230 compares the count value CNT_Value received from the gate driving voltage compensator 601 to the gate voltage setting data V_DATA1 and outputs the power control signal V_DATA2. The gate voltage setting data V_DATA1 includes setting values to decrease a level of the gate off voltage Voff as the driving time of the display apparatus increases. Thus, the comparator 230 determines the driving time corresponding to the count value CNT_Value and outputs the power control signal V_DATA2 based on the setting value which corresponds to the determined driving time.

The first memory 210 may receive the power control signal V_DATA2 from the comparator 230. The first memory 210 may store the power control signal V_DATA2.

The power generator 700 may receive the power control signal V_DATA2 from the first memory 210. The power generator 700 may adjust the level of the gate off voltage Voff based on the power control signal V_DATA2 and output the gate off voltage Voff. The power generator 700 may further adjust the level of the gate on voltage Von based on the power control signal V_DATA2 and output the gate on voltage Von.

The power generator 700 may communicate with the first memory 210 by I²C protocol. For example, the power generator 700 may read the power control signal V_DATA2 from the first memory 210 by I²C protocol.

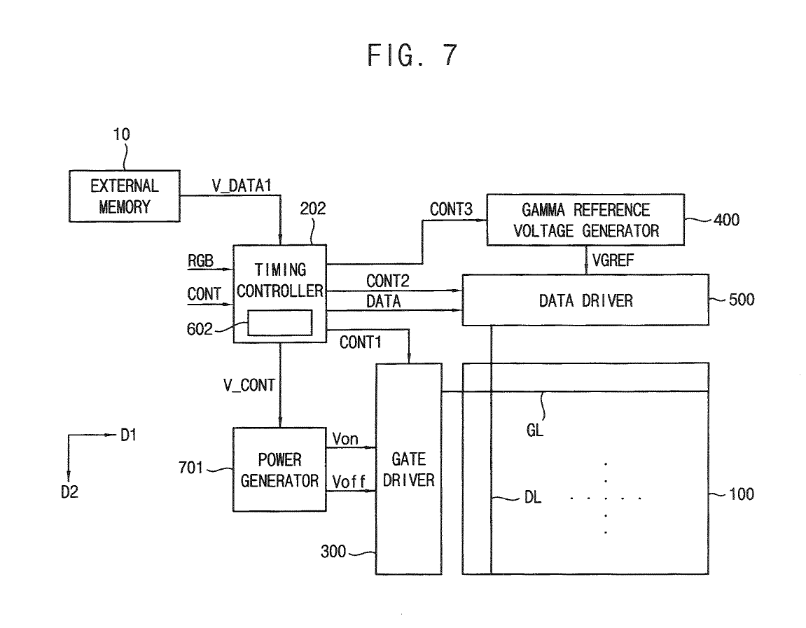

FIG. 7 is a block diagram illustrating a display apparatus according to an exemplary embodiment of the inventive concept.

The display apparatus according to the illustrated exemplary embodiment is substantially the same as the display apparatus in FIGS. 1 to 3 except for a timing controller 201, a gate driving power compensator 602 and a power generator 701. Thus, the same reference numerals will be used to refer to same or like parts as those described in with reference to FIGS. 1 to 3 and any further repetitive explanation concerning the above elements will be omitted.

Referring to FIG. 7, the display apparatus includes a display panel 100, a panel driver and a power generator 701. The panel driver includes a timing controller 202, a gate driver 300, a gamma reference voltage generator 400, a data driver 500 and a gate driving voltage compensator 601.

The timing controller 202 receives input image data RGB and an input control signal CONT from an external apparatus. The timing controller 202 may receive a gate voltage setting data V_DATA1 from an external memory 10. The external memory 10 may be an electrically erasable programmable read-only memory (EEPROM).

The timing controller 202 generates a first control signal CONT1, a second control signal CONT2, a third control signal CONT3 and a data signal DATA based on the input image data RGB and the input control signal CONT. The timing controller 202 generates the power control signal V_CONT based on the gate voltage setting data V_DATA1 and the first control signal CONT1.

The timing controller 202 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 202 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 202 generates the data signal DATA based on the input image data RGB. The timing controller 202 outputs the data signal DATA to the data driver 500.

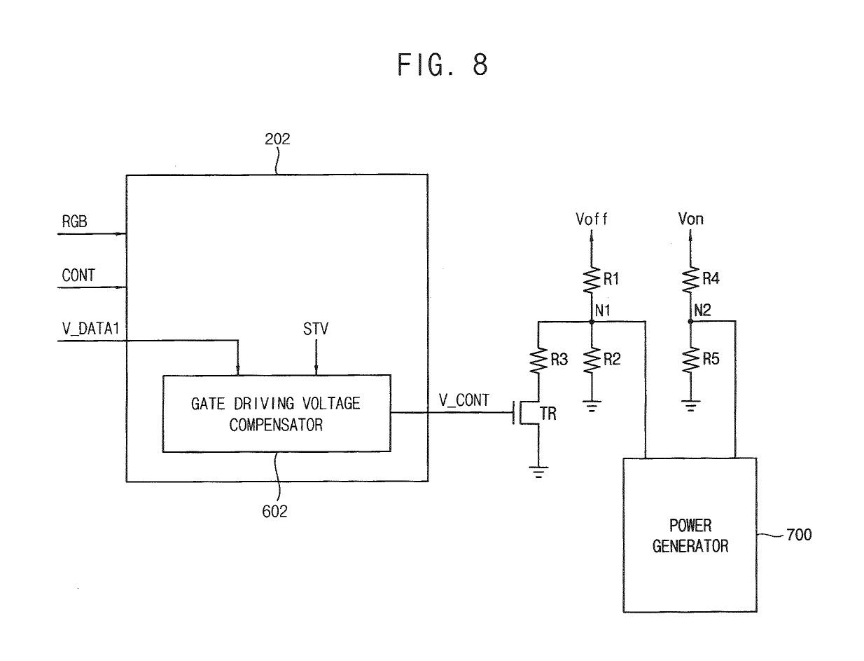

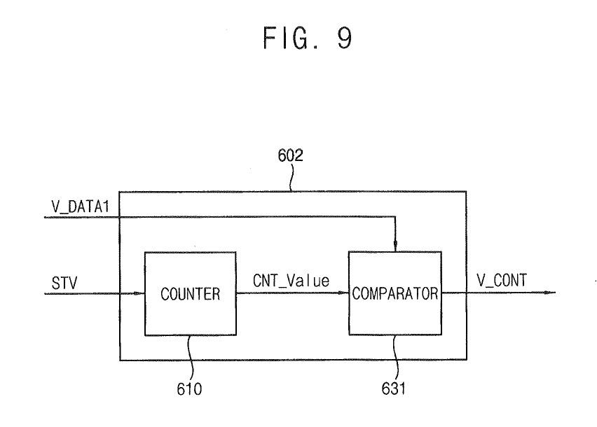

The timing controller 202 generates the power control signal V_CONT to control an output of the power generator 701 based on the gate voltage setting data V_DATA1 and the first control signal CONT1. The timing controller 202 outputs the power control signal V_CONT to the power generator 701. The timing controller 202 includes the gate driving voltage compensator 602 generating the power control signal V_CONT. For example, the gate driving voltage compensator 602 may generate the power control signal V_CONT based on the gate voltage setting data V_DATA1 and the vertical start signal. A structure and an operation of the gate driving voltage compensator 602 are explained in detail referring to FIGS. 8 and 9.

The power generator 701 may output a gate on voltage Von and a gate off voltage Voff based on the power control signal V_CONT. A level of the gate on voltage may be adjusted based on the power control signal V_CONT. A level of the gate on voltage may be adjusted based on the power control signal V_CONT.

The gate driver 300 may receive the first control signal CONT1 from the timing controller 202. The gate driver 300 may receive the gate on voltage Von and the gate off voltage Voff from the power generator 701.

The gate driver 300 generates gate signals driving the gate lines GL based on the gate on voltage Von and the gate off voltage Voff in response to the first control signal CONT1.

FIG. 8 is a block diagram illustrating the timing controller 202 and the power generator 701 of FIG. 7. FIG. 9 is a block diagram illustrating the gate driving voltage compensator 602 of FIG. 8.

Referring to FIGS. 7 to 9, the timing controller 202 includes the gate driving voltage compensator 602.

The gate driving voltage compensator 602 may generate the power control signal V_CONT based on the gate voltage setting data V_DATA1 received from the external memory 10 and the first control signal CONT1. The gate driving voltage compensator 600 may output the power control signal V_CONT. For example, the gate driving voltage compensator 600 may generate the power control signal V_CONT based on the gate voltage setting data V_DATA1, the vertical start signal STV of the first control signal CONT1. The vertical start signal STV is a signal to start an operation of the gate driver 300.

The gate voltage setting data V_DATA1 may include setting values to adjust output values of the power generator 701 according to driving time of the display apparatus. For example, when the driving time of the display apparatus increases, the setting values of the gate voltage setting data V_DATA1 reduce the gate off voltage Voff of the output of the power generator 701. For example, when the driving time of the display apparatus increases, the setting values of the gate voltage setting data V_DATA1 reduce the gate on voltage Von of the output of the power generator 701.

The gate driving voltage compensator 602 may include a counter 610 and a comparator 631.

The counter 610 may count the driving time of the display apparatus and may output a count value CNT_Value. For example, the counter 610 may count the number of the vertical start signal STV outputted from the timing controller 200 to output the count value CNT_Value. The count value CNT_Value may be accumulated for every vertical start signal STV. Alternatively, the count value CNT_Value may be accumulated for some vertical start signals STV.

The comparator 631 compares the count value CNT_Value to the gate voltage setting data V_DATA1 and outputs the power control signal V_CONT. The gate voltage setting data V_DATA1 includes setting values to decrease a level of the gate off voltage Voff as the driving time of the display apparatus increases. Thus, the comparator 630 determines the driving time corresponding to the count value CNT_Value and outputs the power control signal V_CONT based on the setting value which corresponds to the determined driving time.

The power generator 701 may receive the power control signal V_CONT from the gate driving voltage compensator 602. The power generator 701 may adjust the level of the gate off voltage Voff based on the power control signal V_CONT and output the gate off voltage Voff. The power generator 700 may further adjust the level of the gate on voltage Von based on the power control signal V_CONT and output the gate on voltage Von.

The power generator 701 includes a first output terminal N1 and a second output terminal N2.

The first output terminal N1 may be electrically connected to first ends of a first output resistor R1, a first feedback resistor R2 and a second feedback resistor R3.

A second end of the first output resistor R1 may be electrically connected to the gate driver 300. The gate off voltage Voff may be applied to the first output resistor R1. A second end of the first feedback resistor R2 may be connected to a ground.

A second end of the second feedback resistor R3 may be electrically connected to a source electrode of a switching element TR. A gate electrode of the switching element TR may be electrically connected to the gate driving voltage compensator 602 to receive the power control signal V_CONT. A drain electrode of the switching element TR may be connected to a ground. The power control signal V_CONT may be a voltage to turn on the switching element TR

When the power generator 701 receives the power control signal V_CONT having a high level from the gate driving voltage compensator 602, the switching element TR is turned on. Thus, a current flows through the second feedback resistor R3 so that a level of the gate off voltage Voff applied to the first output resistor R1 decreases.

A single voltage compensating circuit including the switching element TR and the second feedback resistor R3 is illustrated in the present exemplary embodiment. Alternatively, a plurality of the voltage compensating circuits may be included according to the number of different levels of the gate off voltage Voff. The plurality of the voltage compensating circuits may be connected to the first output terminal N1 in parallel.

The second output terminal N2 may be electrically connected to first ends of a second output resistor R4 and a third feedback resistor R5. A second end of the second output resistor R4 may be electrically connected to the gate driver 300. The gate on voltage Von may be applied to the second output resistor R4. A second end of the third feedback resistor R5 may be connected to a ground. Although not shown in figures, the voltage compensating circuit may be connected to the second output node N2.

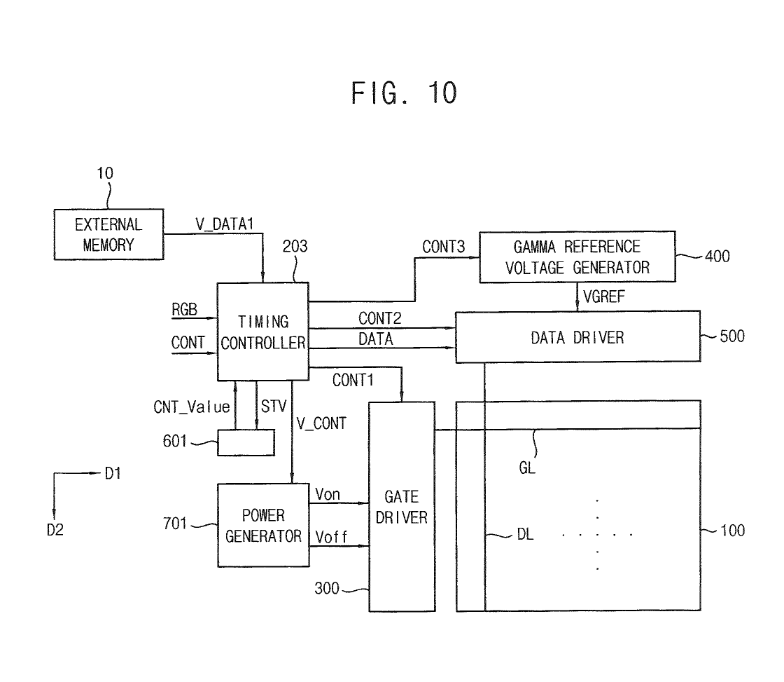

FIG. 10 is a block diagram illustrating a display apparatus according to an exemplary embodiment of the inventive concept.

The display apparatus according to the illustrated exemplary embodiment is substantially the same as the display apparatus in FIGS. 4 to 6 except for a timing controller 203 and a power generator 701. Thus, the same reference numerals will be used to refer to same or like parts as those described in with reference to FIGS. 4 to 6 and any further repetitive explanation concerning the above elements will be omitted.

Referring to FIG. 10, the display apparatus includes a display panel 100, a panel driver and a power generator 701. The panel driver includes a timing controller 203, a gate driver 300, a gamma reference voltage generator 400, a data driver 500 and a gate driving voltage compensator 601.

The timing controller 203 receives input image data RGB and an input control signal CONT from an external apparatus. The timing controller 201 may receive a gate voltage setting data V_DATA1 from an external memory 10. The external memory 10 may be an electrically erasable programmable read-only memory (EEPROM).

The timing controller 203 generates a first control signal CONT1, a second control signal CONT2, a third control signal CONT3 and a data signal DATA based on the input image data RGB and the input control signal CONT.

The timing controller 203 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 203 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 203 generates the data signal DATA based on the input image data RGB. The timing controller 203 outputs the data signal DATA to the data driver 500.

The timing controller 203 may output the first control signal CONT1 to the gate driving voltage compensator 601. For example, the timing controller 203 may output the vertical start signal STV of the first control signal CONT1 to the gate driving voltage compensator 601.

The driving voltage compensator 601 may count the driving time of the display apparatus and may output a count value CNT_Value. For example, the driving voltage compensator 601 may count the number of the vertical start signal STV to output the count value CNT_Value.

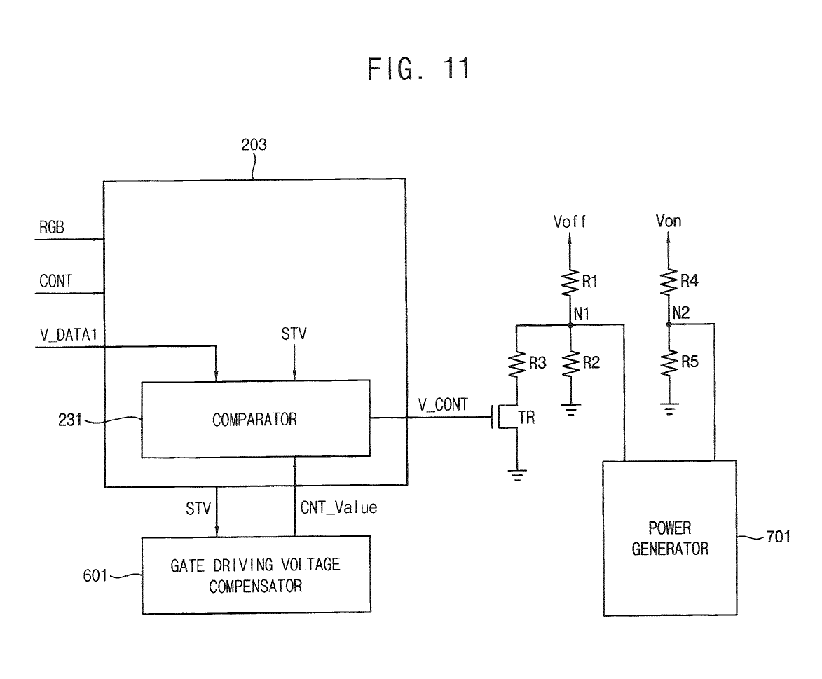

The timing controller 203 may generate the power control signal V_DATA2 for controlling an output of the power generator 701 based on the gate voltage setting data V_DATA1 and the count value CNT_Value. The timing controller 203 may output the power control signal V_CONT to the power generator 701. The timing controller 203 includes a comparator generating the power control signal V_CONT. For example, the comparator may generate the power control signal V_CONT based on the count value CNT_Value received from the gate driving voltage compensator 601. A structure and an operation of the comparator and the gate driving voltage compensator 601 are explained in detail referring to FIG. 11.

The power generator 701 may output a gate on voltage Von and a gate off voltage Voff based on the power control signal V_CONT. A level of the gate on voltage may be adjusted based on the power control signal V_CONT. A level of the gate on voltage may be adjusted based on the power control signal V_CONT.

The gate driver 300 may receive the first control signal CONT1 from the timing controller 203. The gate driver 300 may receive the gate on voltage Von and the gate off voltage Voff from the power generator 701.

The gate driver 300 generates gate signals driving the gate lines GL based on the gate on voltage Von and the gate off voltage Voff in response to the first control signal CONT1.

FIG. 11 is a block diagram illustrating a timing controller, a gate driving voltage compensator and a power generator of FIG. 10.

Referring to FIGS. 10 and 11, the timing controller 203 includes the comparator 231.

The comparator 231 may generate the power control signal V_CONT based on the gate voltage setting data V_DATA1 received from the external memory 10 and the count value CNT_Value received from the gate driving voltage compensator 601. The comparator 231 may output the power control signal V_CONT.

The gate driving voltage compensator 601 may generate the count value CNT_Value based on the first control signal CONT1. The gate driving voltage compensator 601 may output the first control signal CONT1. For example, the gate driving voltage compensator 601 may generate the count value CNT_Value based on the vertical start signal STV to start an operation of the gate driver 300.

The gate voltage setting data V_DATA1 may include setting values to adjust output values of the power generator 701 according to driving time of the display apparatus. For example, when the driving time of the display apparatus increases, the setting values of the gate voltage setting data V_DATA1 reduce the gate off voltage Voff of the output of the power generator 701. For example, when the driving time of the display apparatus increases, the setting values of the gate voltage setting data V_DATA1 reduce the gate on voltage Von of the output of the power generator 701.

The comparator 231 compares the count value CNT_Value received from the gate driving voltage compensator 601 to the gate voltage setting data V_DATA1 and outputs the power control signal V_CONT. The gate voltage setting data V_DATA1 includes setting values to decrease a level of the gate off voltage Voff as the driving time of the display apparatus increases. Thus, the comparator 230 determines the driving time corresponding to the count value CNT_Value and outputs the power control signal V_CONT based on the setting value which corresponds to the determined driving time.

The power generator 701 may receive the power control signal V_CONT from the comparator 231. The power generator 701 may adjust the level of the gate off voltage Voff based on the power control signal V_CONT and output the gate off voltage Voff. The power generator 701 may further adjust the level of the gate on voltage Von based on the power control signal V_CONT and output the gate on voltage Von.

The power generator 701 includes a first output terminal N1 and a second output terminal N2.

The first output terminal N1 may be electrically connected to first ends of a first output resistor R1, a first feedback resistor R2 and a second feedback resistor R3.

A second end of the first output resistor R1 may be electrically connected to the gate driver 300. The gate off voltage Voff may be applied to the first output resistor R1. A second end of the first feedback resistor R2 may be connected to a ground.

A second end of the second feedback resistor R3 may be electrically connected to a source electrode of a switching element TR. A gate electrode of the switching element TR may be electrically connected to the gate driving voltage compensator 602 to receive the power control signal V_CONT. A drain electrode of the switching element TR may be connected to a ground. The power control signal V_CONT may be a voltage to turn on the switching element TR

When the power generator 701 receives the power control signal V_CONT having a high level from the gate driving voltage compensator 602, the switching element TR is turned on. Thus, a current flows through the second feedback resistor R3 so that a level of the gate off voltage Voff applied to the first output resistor R1 decreases.

A single voltage compensating circuit including the switching element TR and the second feedback resistor R3 is illustrated in the present exemplary embodiment. Alternatively, a plurality of the voltage compensating circuits may be included according to the number of different levels of the gate off voltage Voff. The plurality of the voltage compensating circuits may be connected to the first output terminal N1 in parallel.

The second output terminal N2 may be electrically connected to first ends of a second output resistor R4 and a third feedback resistor R5. A second end of the second output resistor R4 may be electrically connected to the gate driver 300. The gate on voltage Von may be applied to the second output resistor R4. A second end of the third feedback resistor R5 may be connected to a ground. Although not shown in figures, the voltage compensating circuit may be connected to the second output node N2.

According to the present exemplary embodiment, the display apparatus may determine the driving time of the display apparatus by counting an internal clock signal of the timing controller. The display apparatus adjusts the gate driving voltage applied to the gate driver according to the driving time of the display apparatus so that a driving reliability of the thin film transistor may be improved. Thus, the display quality of the display apparatus may be improved.

A display apparatus of the illustrated exemplary embodiments may be applied to a mobile type display apparatus such as a mobile phone, a note book computer and a tablet computer, a fixed type display apparatus such as a television and a monitor for a desktop, and a display of a general appliance such as a refrigerator, a washing machine and an air conditioner.

The foregoing is illustrative of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific exemplary embodiments disclosed, and that modifications to the disclosed exemplary embodiments, as well as other exemplary embodiments, are intended to be included within the scope of the appended claims. The inventive concept is defined by the following claims, with equivalents of the claims to be included therein.

What is claimed is:

1. A display apparatus comprising:
a display panel including a gate line and a pixel electrically connected to the gate line;
a gate driver configured to set a voltage level and an output timing of a gate signal applied to the gate line based on a gate driving voltage and a first control signal, the gate driving voltage including a gate on voltage and a gate off voltage;
a counter configured to increase a count value based on the first control signal; and
a power generator configured to adjust a level of the gate driving voltage based on the count value.

2. The display apparatus of claim 1, wherein the first control signal includes a vertical start signal to start an operation of the gate driver, and
the counter is configured to increase the count value based on an output of the vertical start signal.

3. The display apparatus of claim 1, wherein as the count value increases, the power generator decreases a level of the gate driving voltage.

4. The display apparatus of claim 1, further comprising a comparator configured to receive a gate voltage setting data including a level of the gate driving voltage according to a driving time of the display apparatus, to compare the count value to the gate voltage setting data and to generate a power control signal,
wherein the power generator adjusts a level of the gate driving voltage based on the power control signal.

5. The display apparatus of claim 4, further comprising a timing controller configured to output the first control signal for controlling a driving timing of the gate driver, to receive the gate voltage setting data from an external memory and to output the gate voltage setting data to the comparator.

6. The display apparatus of claim 4, wherein the power generator comprises:
an output resistor to which the gate off voltage is applied;
a first feedback resistor connected to the output resistor; and
a voltage compensating circuit connected to the output resistor and the first feedback resistor,
the voltage compensating circuit is configured to adjust a level of the gate off voltage based on the power control signal.

7. The display apparatus of claim 6, wherein the voltage compensating circuit comprises a second feedback resistor and a switching element connected to the second feedback resistor in series, and
a gate electrode of the switching element is electrically connected to the comparator to receive the power control signal.

8. The display apparatus of claim 1, further comprising a memory configured to store the count value in a predetermined time cycle.

9. A method of driving a display apparatus, the method comprising:
increasing a count value based on a first control signal, the first control signal being for controlling an operation of a gate driver;
outputting a power control signal based on the count value; and
adjusting a level of a gate driving voltage applied to the gate driver based on the power control signal.

10. The method of claim 9, wherein the gate driving voltage includes a gate on voltage and a gate off voltage, the gate on voltage and the gate off voltage determining a level of a gate signal,
the first control signal includes a vertical start signal to start an operation of the gate driver, and
the count value increases based on an output of the vertical start signal.

11. The method of claim 9, wherein as the count value increases, the power generator decreases a level of the gate driving voltage.

12. The method of claim 9, further comprising:
receiving a gate voltage setting data including a level of the gate driving voltage according to a driving time of the display apparatus; and
comparing the count value to the gate voltage setting data to generate a power control signal.

13. The method of claim 9, further comprising:
storing the power control signal to a first memory; and
reading the power control signal from the first memory by I²C protocol.

14. The method of claim 9, wherein the adjusting the level of the gate driving voltage uses a power generator comprising an output resistor to which the gate off voltage is applied and a voltage compensating circuit connected to the output resistor and the first feedback resistor,
the voltage compensating circuit is configured to adjust a level of the gate off voltage based on the power control signal.

15. The method of claim 14, wherein the voltage compensating circuit comprises a second feedback resistor and a switching element connected to the second feedback resistor in series, and
a gate electrode of the switching element is electrically connected to the comparator to receive the power control signal.

16. The method of claim 9, further comprising storing the count value in a predetermined time cycle.

17. A display apparatus, comprising:
a display panel including a gate line and a pixel electrically connected to the gate line;
a gate driver configured to set a voltage level and an output timing of a gate signal applied to the gate line based on a gate driving voltage and a first control signal, the gate driving voltage including a gate on voltage and a gate off voltage;
a counter configured to increase a count value based on the first control signal;
a power generator configured to adjust a level of the gate driving voltage based on the count value;
a comparator configured to receive a gate voltage setting data including a level of the gate driving voltage according to a driving time of the display apparatus, to compare the count value to the gate voltage setting data and to generate a power control signal and adjust a level of the gate driving voltage based on the power control signal; and
a timing controller configured to output the first control signal for controlling a driving timing of the gate driver, to receive the gate voltage setting data from an external memory and to output the gate voltage setting data to the comparator.

18. The display apparatus of claim 17, wherein the power generator comprises:
an output resistor to which the gate off voltage is applied;
a first feedback resistor connected to the output resistor; and
a voltage compensating circuit connected to the output resistor and the first feedback resistor,
the voltage compensating circuit is configured to adjust a level of the gate off voltage based on the power control signal.

19. The display apparatus of claim 18, wherein the voltage compensating circuit comprises a second feedback resistor and a switching element connected to the second feedback resistor in series, and
a gate electrode of the switching element is electrically connected to the comparator to receive the power control signal.

20. The display apparatus of claim 17, wherein the count value is stored in the external memory in a predetermined time cycle.
